(19) United States
(12) Patent Application Publication
(10) Pub. No.: US 2026/0225231 A1
(43) Pub. Date: Aug. 6, 2026

(54) Universal Gripper

(71) Applicant: VOYAGER SPACE HOLDINGS, INC., Denver, CO (US)

(72) Inventors: Keith Drake, Denver, CO (US); Calvin Murphy, Denver, CO (US); Young Tai Choi, Laurel, MD (US); Norman M. Wereley, North Beach, MD (US); Thomas Leps, El Segundo, CA (US); Christine Hartzell, Dayton, MD (US)

(21) Appl. No.: 19/154,761

(22) PCT Filed: Feb. 20, 2024
(86) PCT No.: PCT/US2024/016436

§ 371 Date: Aug. 7, 2025

Related U.S. Application Data
(60) Provisional application No. 63/486,024, filed on Feb. 20, 2023.

(51) Int. Cl. B25J 9/16; B25J 15/00; B25J 15/02; B64G 4/00

(52) U.S. Cl. CPC B25J 9/1612; B25J 15/0023; B25J 15/0033; B25J 15/02; B64G 4/00; B64G 2004/005

(57) ABSTRACT

Systems and methods herein provide for grasping an object. In one embodiment, a gripping system includes a magnet module (204), an elastic bladder (208) affixed to the magnet module (204), and a magnetorheological (MR) fluid contained within the elastic bladder. The system also includes a controller operable to vary a magnetic field of the magnet module (204). The magnet module (204) directs the magnetic field to the MR fluid in the elastic bladder (208) to rigidize the elastic bladder (208) about the object to grip the object with the elastic bladder (208).

### CROSS REFERENCE TO RELATED APPLICATIONS

This patent application claims priority to, and thus the benefit of an earlier filing date from, U.S. Provisional Patent Application No. 63/486,024 (filed Feb. 20, 2023), the contents of which are hereby incorporated by reference.

### BACKGROUND

The United States Space Force (USSF) has identified the need for Active Debris Remediation (ADR) and On-Orbit Serving, Assembly, and Manufacturing (OSAM) activities. OSAM tasks require gripping and holding unfamiliar objects with varying external geometries and surface properties. Current space robotic grippers typically utilize mechanical claws to create a force-closure grasp. These grasper type grippers tend to create very high concentrated loads on a space object, which could damage the space object and create secondary debris. These grasper type grippers are also typically optimized for grasping objects with a very narrow variety of geometries and sizes. The ability to securely grab a larger variety of structures in in-space applications with distributed gripping forces is simply not possible with current mechanical robotic grippers. Similar problems can also be found here on Earth.

### SUMMARY

Systems and methods herein provide for magnetic gripping of objects, such as satellites, space debris, or other objects as desired. In one embodiment, a gripping system includes a magnet module, an elastic bladder affixed to the magnet module, a magnetorheological (MR) fluid contained within the elastic bladder. The system also includes a controller operable to vary a magnetic field of the magnet module, whereby the magnet module directs the magnetic field to the MR fluid in the elastic bladder to rigidize the elastic bladder about an object to grip the object with the elastic bladder.

In some embodiments, the gripping system includes another magnet module, and another elastic bladder filled with the MR fluid and affixed to the other magnet module. The controller is further operable to vary a magnetic field of the other magnet module. The other magnet module directs the magnetic field of the other magnet module to the MR fluid in the other elastic bladder to rigidize the other elastic bladder about the object to grip the object with both clastic bladders. The gripping system may also include a linear actuator configured with the elastic bladders and the magnet modules. In this regard, the elastic bladders may oppose each other on the linear actuator, and the controller may move the elastic bladders towards each other via the linear actuator to grip the object. For example, the elastic bladder and the magnet module are configured on a first arm, and the other elastic bladder and the other magnet module are configured on a second arm hingeably affixed with the first arm to the linear actuator. The linear actuator may draw the two arms towards the object from opposing sides of the object.

The magnet module may include an array of electropermanent magnets (EPMs), one or more electromagnets, or a combination thereof. In some embodiments, the array is a 4×4 array of EPMs. In this regard, the EPMs are activated with adjacent EPMs having opposite poles of magnetic flux in a long range mode of operation, and the EPMs are activated with adjacent EPMs having same poles of magnetic flux in a short range mode of operation.

In another embodiment, a method includes positioning a gripping system proximate to a target graspable feature of an object, the gripping system comprising a magnet module, an elastic bladder affixed to the magnet module, and a magnetorheological (MR) fluid contained within the elastic bladder. And, via a controller, the method includes varying a magnetic field of the magnet module, whereby the magnet module directs the magnetic field to the MR fluid in the elastic bladder to rigidize the elastic bladder about the target graspable feature of object to grip the object with the elastic bladder.

In another embodiment, a non-transitory computer readable medium comprises instructions that, when executed by a controller, direct the controller to position a gripping system proximate to a target graspable feature of an object, the gripping system comprising a magnet module, an elastic bladder affixed to the magnet module, and a magnetorheological (MR) fluid contained within the elastic bladder. The instructions also directed the controller to vary a magnetic field of the magnet module, whereby the magnet module directs the magnetic field to the MR fluid in the elastic bladder to rigidize the elastic bladder about an object to grip the object with the elastic bladder.

The various embodiments disclosed herein may be implemented in a variety of ways as a matter of design choice. For example, some embodiments herein are implemented in hardware, whereas other embodiments may include processes that are operable to implement and/or operate the hardware. Other exemplary embodiments, including hardware, software, firmware, and various combinations thereof are described below.

### BRIEF DESCRIPTION OF THE DRAWINGS

Some embodiments are now described, by way of example only, and with reference to the accompanying drawings. The same reference number represents the same element or the same type of element on all drawings.

FIG. 1 is an exemplary scenario of a spacecraft grabbing another spacecraft in orbit using a magnetically activated gripping system.

FIGS. 2-5 illustrate various exemplary gripping system embodiments.

FIG. 6 is a cutaway view of an exemplary electropermanent magnet (EPM) gripping system.

FIG. 7 is a perspective view of an exemplary EPM array.

FIGS. 8 and 9 are graphs illustrating exemplary magnetic densities for long range and short range operations of the EPM array of FIG. 7.

FIG. 10 is a perspective view of an elastic bladder containing a magnetorheological (MR) fluid that is affixed to the EPM array of FIG. 7.

FIGS. 11A-11F are graphs illustrating various tests of a gripping module with an array of EPMs gripping a PVC pipe having a 2.4″ outer diameter.

FIGS. 12A-12F are graphs illustrating various tests of a gripping module with an array of EPMs gripping a PVC pipe having a 4.3″ outer diameter.

FIG. 13 is a cutaway view of an exemplary electromagnet (EM) gripping system.

FIG. 14 is a graph illustrating exemplary magnetic densities for the EM of FIG. 13.

FIG. 15 is an overhead view of the EM of FIG. 13 illustrating poles of the EM.

FIGS. 16A-16F are graphs illustrating various tests of a gripping module with an EM gripping a PVC pipe having a 2.4″ outer diameter.

FIGS. 17A-17F are graphs illustrating various tests of a gripping module with an EM gripping a PVC pipe having a 4.3″ outer diameter.

FIG. 18 is a flowchart of an exemplary method for operating a gripping system.

FIG. 19 is a block diagram of an exemplary computing system in which a computer readable medium provides instructions for performing one or more methods herein.

### DETAILED DESCRIPTION OF THE DRAWINGS

The figures and the following description illustrate various exemplary embodiments. It will thus be appreciated that those skilled in the art will be able to devise various arrangements that, although not explicitly described or shown herein, embody various principles of design and/or operation and are included within the scope of the embodiments. Furthermore, any examples described herein are intended to aid in understanding the principles of the embodiments and are to be construed as being without limitation to such specifically recited examples and conditions.

A magnet is a material or object that produces a magnetic field. The magnetic field provides a force that pulls on other ferromagnetic materials, such as iron. Materials that can be magnetized, which are also the ones that are strongly attracted to a magnet, are called ferromagnetic. These include iron, nickel and cobalt, some alloys of rare-earth metals, and some naturally occurring minerals. Although ferromagnetic materials are the only ones attracted to a magnet strongly enough to be commonly considered magnetic, all other substances respond weakly to a magnetic field, by one of several other types of magnetism.

Ferromagnetic materials can be divided into magnetically “soft” materials (e.g., annealed iron), which can be magnetized but do not tend to stay magnetized, and magnetically “hard” materials, which do. Permanent magnets are made from “hard” ferromagnetic materials such as alnico, aluminum, nickel, cobalt alloy, alloys of neodymium and other rare earth materials, and ferrite that are subjected to special processing in a strong magnetic field during manufacture to align their internal microcrystalline structure, making them very hard to demagnetize. To demagnetize a saturated magnet, a certain magnetic field is applied, and such depends on the coercivity of the respective material. Hard materials have high coercivity, whereas soft materials have low coercivity. The overall strength of a magnet is measured by its BH product. The local strength of magnetism in a material is measured by its magnetization.

An electromagnet is a type of magnet in which the magnetic field is produced by an electric current. An electromagnet usually consists of wire wound into a coil about a soft magnetic core material. When an electrical current runs through the wire, the soft magnetic core material creates a magnetic field. The magnetic core concentrates the magnetic flux and makes a more powerful magnet. The magnetic field, however, disappears when the current is turned off.

An electropermanent magnet (EPM), on the other hand, is a type of permanent magnet in which the external magnetic field can be switched on or off by a pulse of electric current in a wire winding (i.e., a coil) around part of the magnet. The magnet consists of two sections, one of a hard magnetic material and one of a soft magnetic material. The direction of magnetization in the soft magnetic material can be switched by a pulse of current in a wire winding about the hard magnetic material. When the magnetically soft and hard materials have opposing magnetizations, the magnet produces no net external field across its poles. But when their direction of magnetization is aligned, the magnet produces an external magnetic field.

A magnetorheological (MR) fluid is a type of smart fluid typically formed with micrometer-sized particles suspended in a carrier fluid (e.g., a type of oil). When subjected to a magnetic field, the fluid greatly increases its apparent viscosity, to the point of becoming a viscoelastic solid. The yield stress of the MR fluid in its active state (i.e., its “on” state) can be accurately controlled by varying a magnetic field intensity to the MR fluid. This feature allows for the possibility to controllably transmit force. In some embodiments disclosed herein, the MR fluid is a bi-disperse mixture of carbonyl iron grains suspended in a silicone oil.

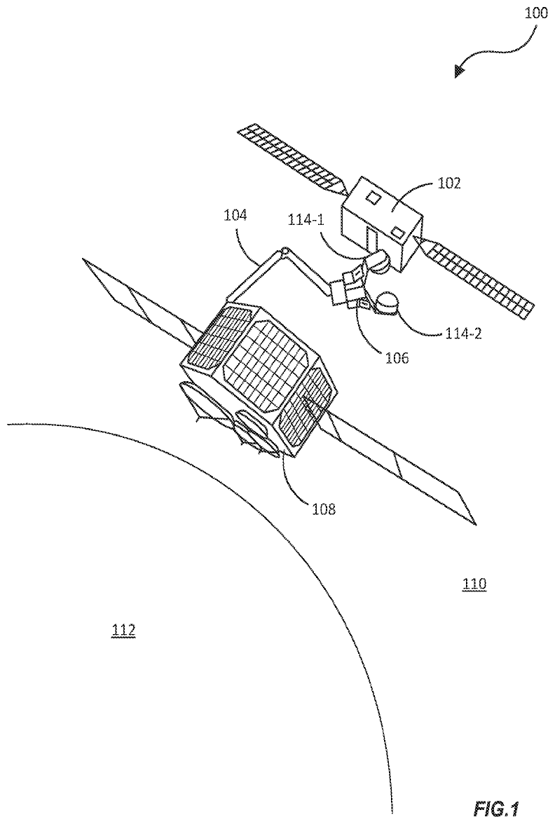

The embodiments herein employ the above features to provide a gripping system that may be used in environments where humans with or without tools would have difficulty grasping various target objects. Examples of such environments include space, underwater, and various other terrestrial applications. For example, FIG. 1 illustrates an exemplary scenario 100 in which a spacecraft 102 (e.g., a satellite) in space 110 and orbiting the earth 112 is in need of servicing, repair, and/or deorbiting (e.g., at the end of the spacecraft 102's useful life). In this scenario, another spacecraft 108 may be launched from Earth 112 and placed in the relatively same orbit as the spacecraft 102. Then, the other spacecraft 108 may be guided into proximity of the spacecraft 102 such that a gripping system 106 may be positioned via a boom 104 proximate to a graspable feature on the spacecraft 102, such as a handhold.

The gripping system 106 may be configured with one or more grasping pads 114 that may be used to surround the graspable feature of the spacecraft 102. These grasping pads 114 may be configured with a flexible/elastic bladder and filled with an MR fluid. The flexible/elastic bladder may be affixed to a magnet module (e.g., an EPM and/or an electromagnet). When the gripping system 106 reaches the graspable feature of the spacecraft 102, a control system (e.g., a controller) aboard the spacecraft 108 may activate the magnet module to produce a magnetic field. The magnet module may direct the magnetic field to the flexible/elastic bladder, which in turn affects the MR fluid within the bladder causing the bladder to stiffen about the graspable feature of the spacecraft 102. For example, when the magnet module is in an “off mode,” the flexible/elastic bladder containing the MR fluid may be operable to conform about a shape of the graspable feature of the spacecraft 102. Once conformed about the shape of the graspable feature of the spacecraft 102, the magnet module may be placed in an “on mode” that causes the flexible/elastic bladder to become rigid about the shape of the graspable feature such that the spacecraft 102 can be gripped and handled as desired.

Various forms of MR fluids exist and may be used within the flexible/elastic bladder, including those with surfactants that may be operable to offset particle sedimentation of the magnetic particles within the MR fluids. However, in space operations, particle sedimentation may not have a significant effect on MR fluids. As such, selection of a particular MR fluid may be a matter of design choice and/or environmental conditions. Similarly, selection of materials for the flexible/elastic bladder, including various synthetic rubbers, may be a matter of design choice and/or environmental conditions.

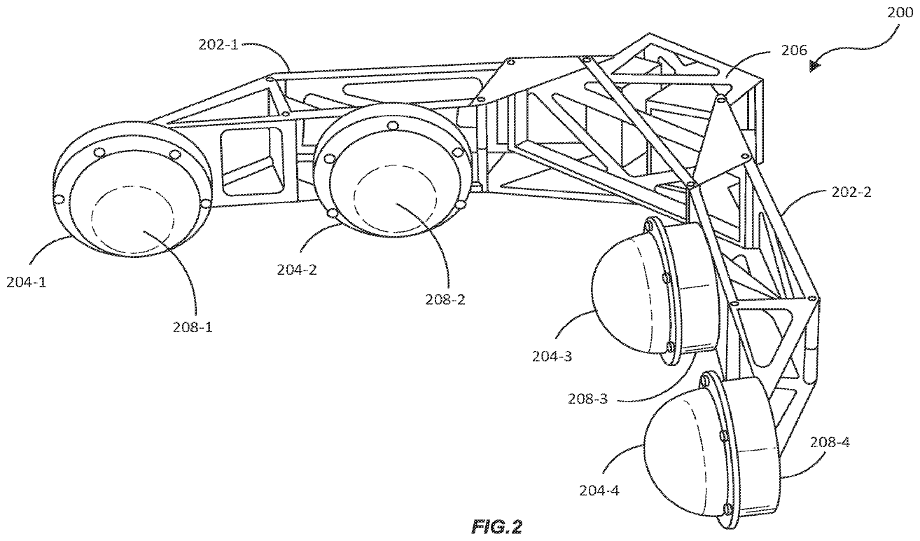

FIGS. 2-5 illustrate various exemplary gripping systems that may be used in the above scenario and/or in various other scenarios. For example, FIG. 2 illustrates a schematic view of an exemplary gripping system 200 in a scissor like configuration with arms 202-1 and 202-2. The arms 202 may be hingeably affixed to an actuator module 206 (e.g., a linear actuator with a motor). And each arm 202 may be configured with a gripper module comprising a magnet module 204 and a flexible/elastic bladder 208 containing MR fluid that is affixed to the magnet module 204. When the gripping system 200 is proximate to a target graspable feature, a control system (not shown) may direct the gripping system 200 to close about the target graspable feature such that one or more of the flexible/elastic bladders 208 conforms about the target graspable feature (e.g., while in the magnet module 204s′ off position). Thereafter, the control system may direct the magnet modules 204 to turn on and direct their magnetic fields to their respective flexible/elastic bladders 208. The magnetic fields cause the flexible/elastic bladders 208 to become rigid and grip the target graspable feature such that an object thereof may be handled as desired.

FIG. 3 illustrates a schematic view of another exemplary gripping system 250 also formed in a scissor like configuration. In this embodiment, the gripping system 250 is configured with two arms 260-1 and 260-2 hingeably attached to a linear actuator module 256. Configured with each of the arms 260 is a magnet module 254 with a flexible/elastic bladder 258 containing an MR fluid. Similar to the embodiment of FIG. 2, when the gripping system 250 is proximate to a target graspable feature, a control system may direct the linear actuator module 252 to close the arm 260 about the graspable feature such that the flexible/elastic bladders 258-1 and 258-2 conform about the graspable feature. Then, the control system may turn on the magnet modules 254 to direct a magnetic field to the flexible/elastic bladders 258 such that the MR fluid inside becomes rigid about the graspable feature and the object with the graspable feature can be handled as desired. Also shown in this embodiment, is a coupling mechanism 262 that allows the gripping system 250 to be configured with a boom or other means for positioning the gripping system 250 in proximity of the target graspable feature.

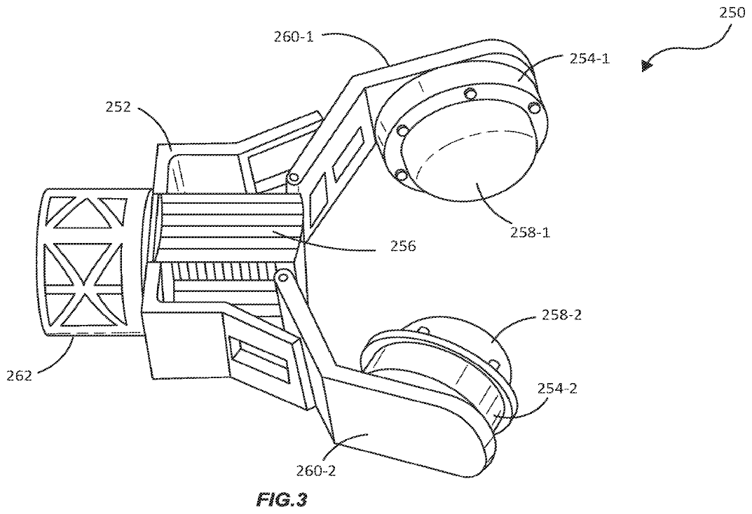

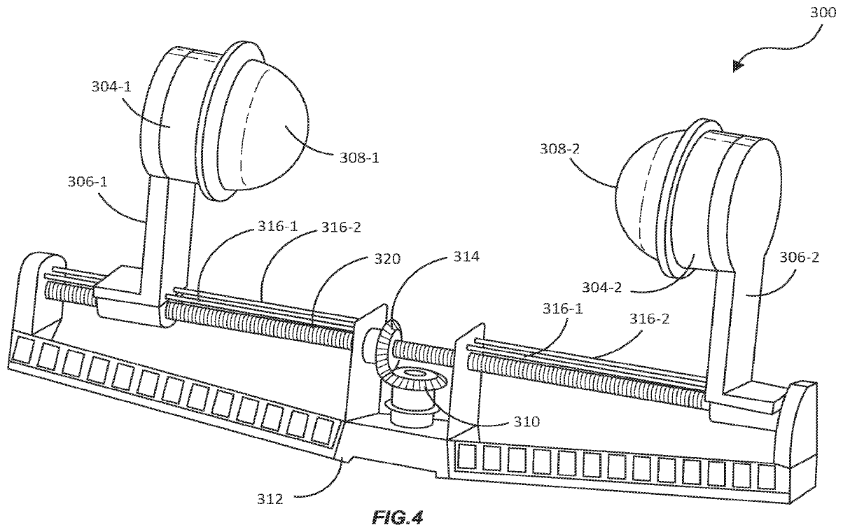

FIG. 4 is a schematic diagram of yet another exemplary gripping system 300. In this embodiment, the gripping system 300 comprises a frame 312 that is used to retain a screw type linear actuator comprising a screw 320 and gears 314 and 310. Arms 306-1 and 306-2 are screwed onto the screw 320 at opposing ends of the screw 320. The arms 306-1 and 306-2 are operable to respectively retain the magnet modules 304-1 and 304-2 and their flexible/elastic bladders 308-1 and 308-2 each containing the MR fluid. With this configuration, a control system may direct a motor to turn the gear 310 in a particular direction such that the gear 314 turns the screw 320 to propel the arms 306 towards the target graspable feature of the object from opposite sides of the object.

When the target graspable feature is engaged and the bladders 308 conform to the target graspable feature, the control system may turn on the magnet modules 304 such that the magnet modules 304 direct a magnetic field to the MR fluid within the flexible/elastic bladders 308. Again, this makes rigid the MR fluid within the flexible/elastic bladders 308 such that the gripping system 300 can retain the target graspable feature for handling an object attached thereto. When the target graspable feature is to be released, the control system may direct the gear 310 to turn in an opposite manner and open the gripping system 300 by reversing the direction of the screw 320 (e.g., the of the gear 314) and thus propagating the arms 306 and the opposite direction. Also illustrated in this embodiment are guide rods 316-1 and 316-2 that are mounted to the frame 312 through through-holes of the arms 306 to maintain the arms 306 in a desired position during operation.

In any of the embodiments disclosed herein, it may be only necessary to include MR fluid bladders and magnet modules in less than an amount arms, as some of arms could include a compressible feature that is operable to provide an opposing force without being filled with MR fluid or requiring magnet operations. For example, in the gripping system 300 embodiment, the arm 306-1 may be configured with a flexible/elastic bladder 308-1 that contains MR fluid while the arm 306-2 may include some flexible/elastic material, such as foam rubber, that is operable to compress against a target graspable feature while the arm 306-1 activates the magnet module 304-1 to direct a magnetic field to the MR fluid contained within the flexible/elastic bladder 308-1. Such may have the advantage of reducing electrical power requirements by controlling fewer magnet modules, particularly in electromagnet embodiments.

FIG. 5 is a schematic diagram of yet another exemplary gripping system 350. In this embodiment, a frame 362 may be configured with rails so as to provide a mechanism for arms 360-1 and 360-2 to roll across the rails via rollers 364. A motor 356 may be operable to provide linear actuation of the arms 360 to open and close about a target graspable feature as discussed herein. In this regard, the arms 360 may be configured with magnet modules 354-1 and 354-2 and elastic/flexible bladders 358-1 and 358-2 containing MR fluid to activate when proximate to the target graspable feature and to disengage when grasping the target graspable feature is no longer desired.

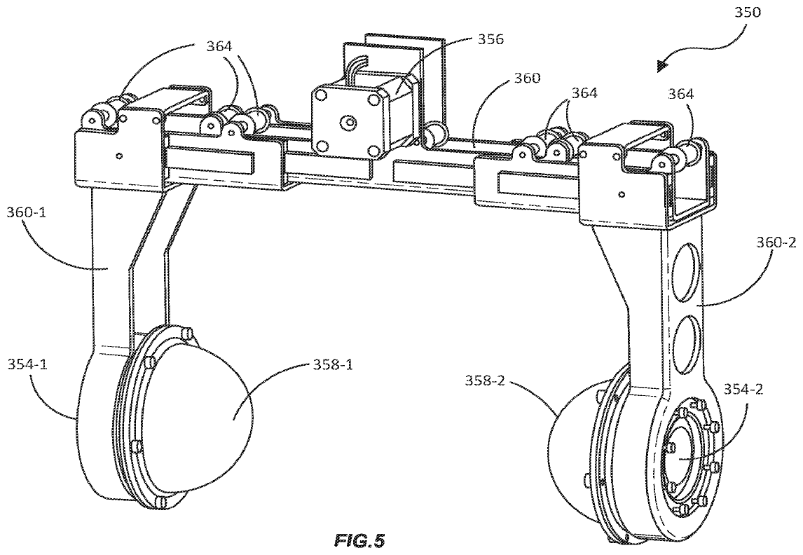

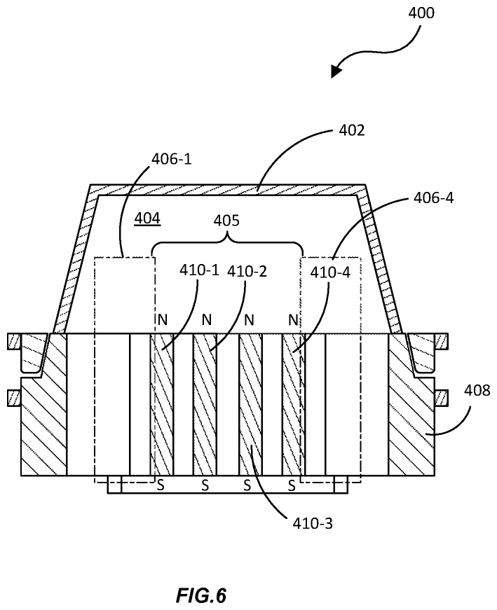

FIG. 6 is a cutaway view of a gripping module 400 configured with an EPM module 405 comprising an array of EPMs 410-1-410-N (where the reference number “N” represents an integer greater than “1” and not necessarily equal to any other “N” reference designated herein). In this embodiment, the EPM module 405 is encased in an aluminum frame 408, as aluminum is generally nonmagnetic and the magnetic field from the EPM module 405 can be more uniformly directed to the MR fluid 404 residing within the flexible/elastic bladder 402 affixed to the aluminum frame 408. As FIG. 6 illustrates a cutaway view of the gripping module 400, only four EPMs 410-1-410-4 are shown. But the number of EPMs 410 in the EPM module 405 may be selected as a matter of design choice.

As shown herein, each of the EPMs 410 are turned on having North poles “N” aligned in the same direction such that they each produce a corresponding magnetic field 406, although some of the magnetic fields are not shown for the sake of simplicity. Thus the South poles “S” of the EPMs 410 are aligned at the bottom of the EPM module 400. The magnetic fields 406 of the EPMs 410 radiate through the MR fluid 404 residing within the flexible/elastic bladder 402. This on operation of the gripping module 400 rigidizes the MR fluid residing within the flexible/elastic bladder 402. Thus, when turned on after the flexible/elastic bladder 402 conforms about a target graspable feature, the flexible elastic bladder 402 becomes rigid and holds the target graspable feature in place. And, when turned off, the flexible/elastic bladder 402 softens and disengages from the target graspable feature.

While shown in the on operation with the North poles of the EPMs 410 aligned in the direction of the flexible/elastic bladder 402 and the MR fluid 404, the EPMs 410 of the EPM module 405 may be operated in a variety of ways as a matter of design choice. For example, when all of the EPMs 410 are turned on and their North poles are aligned in the direction of the flexible/elastic bladder 402, this may be representative of a short range holding force. However, when a longer-range holding attraction is desired, such as when guiding the gripping module 400 towards a target graspable feature, one or more of the EPM 410 may be turned off so as to provide more of a guiding force to the target graspable feature.

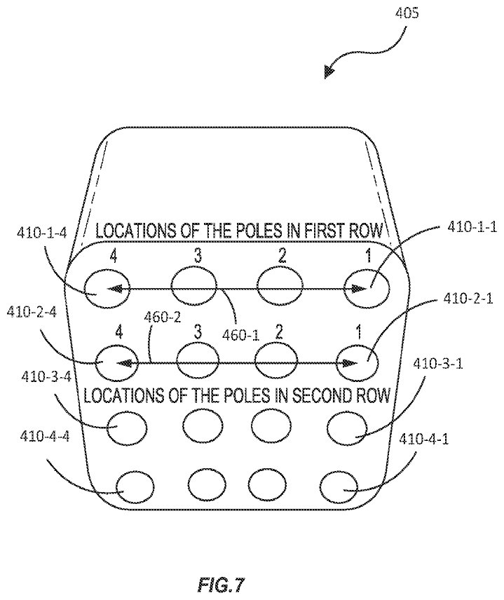

FIG. 7 is a perspective view of the EPM module 405, in one exemplary embodiment. In this embodiment, the EPM module 405 is configured as a 4×4 array of EPMs 410-1-1-410-4-4. The dimensions of the EPM module 405 as well as the EPMs 410 may be configured as a matter of design choice. For example, differently sized EPM modules 405 and/or EPMs 410 may provide differing levels of magnetic density and thus attraction.

FIG. 8 is a graph 500 illustrating the different magnetic densities for two rows of the EPMs 410 of the EPM module 405 of FIG. 7 under short range operation in which generally all of the EPMs 410 in a row are turned on. In this example, the EPM module 405 was being operated with two rows 460-1 and 460-2 of EPMs 410. The graph 500 shows the magnetic density magnitude in milli Teslas (mT) at each pole for various heights from a target object—i.e., a distance from the target object. At 9.85 mm from the target object, the two rows of EPMs 410 have a relatively low magnetic density at each pole (i.e., each EPM 410). However, as the EPM module 405 moves closer in proximity to the target object, the magnetic density increases significantly for each pole (e.g., roughly 130 to 140 mT).

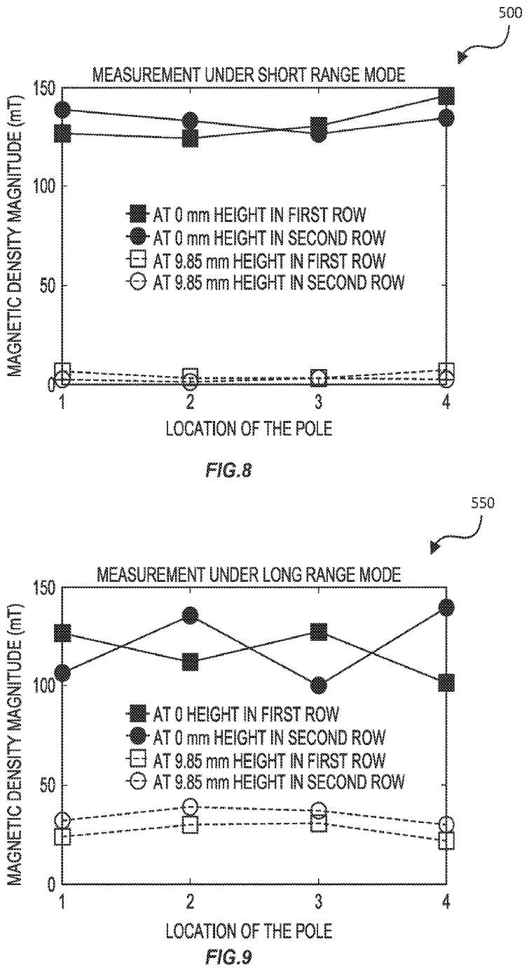

FIG. 9 is a graph 550 illustrating the different magnetic densities for the same two rows of the EPMs 410 of the EPM module 405 of FIG. 7 under long range operation in which some of the EPMs 410 in a row are turned on while others are in a passive state. For example, in the long range operation, adjacent EPMs 410 may have opposite poles. The graph 550 shows the magnetic density in mT at each pole for the same heights of FIG. 8. As can be seen in the graph 550, the EPM module 405 provides a significantly larger magnetic density for each pole at greater distances. Accordingly, the long-range mode of the EPM module 405 may be employed for attraction to a target object. Then, as the EPM module 410 moves in closer proximity to the target object, a control system may change the operation of the EPM module 410 to the short range mode in which the magnetic field is directed to the flexible/elastic bladder embodiments described herein so as to conform to and grasp a graspable feature of a target object.

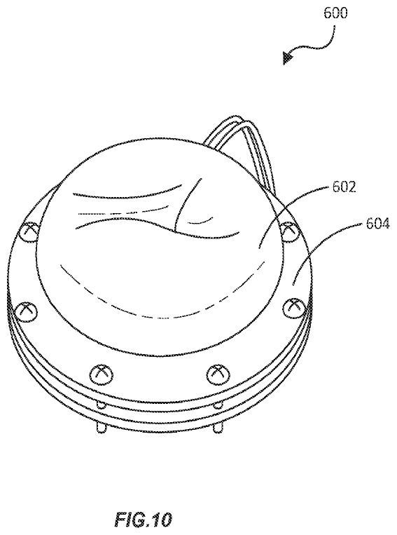

FIG. 10 is a perspective view of a flexible/elastic bladder 600 that may be implemented with any of the magnet modules described herein. The flexible/elastic bladder 600 is configured with a flexible/elastic bladder material 602 (e.g., synthetic rubber or the like) that is operable to hold an MR fluid. The bladder material 602 may be clamped to a magnet module via a circular ring structure 604 that is screwed into the frame of the magnet module such as shown in the aluminum frame 408 of FIG. 6.

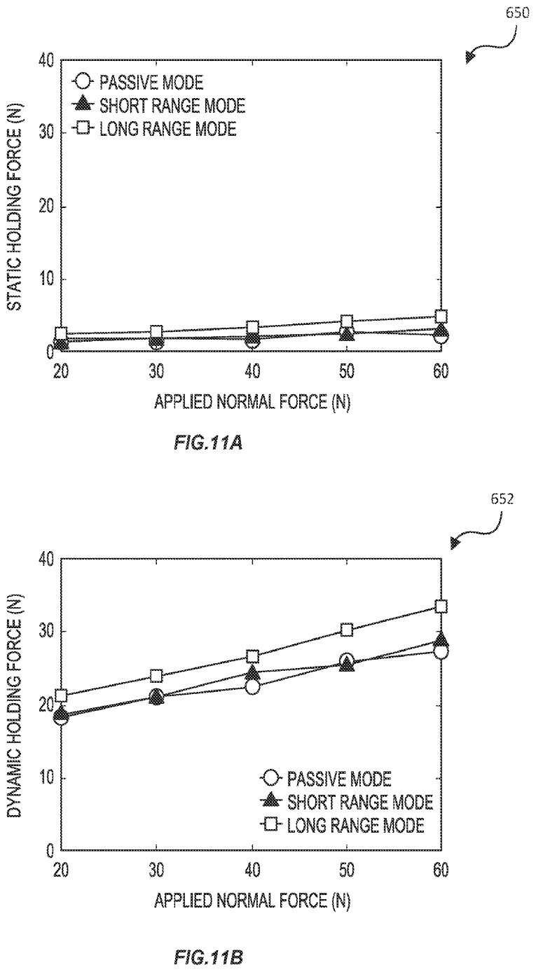

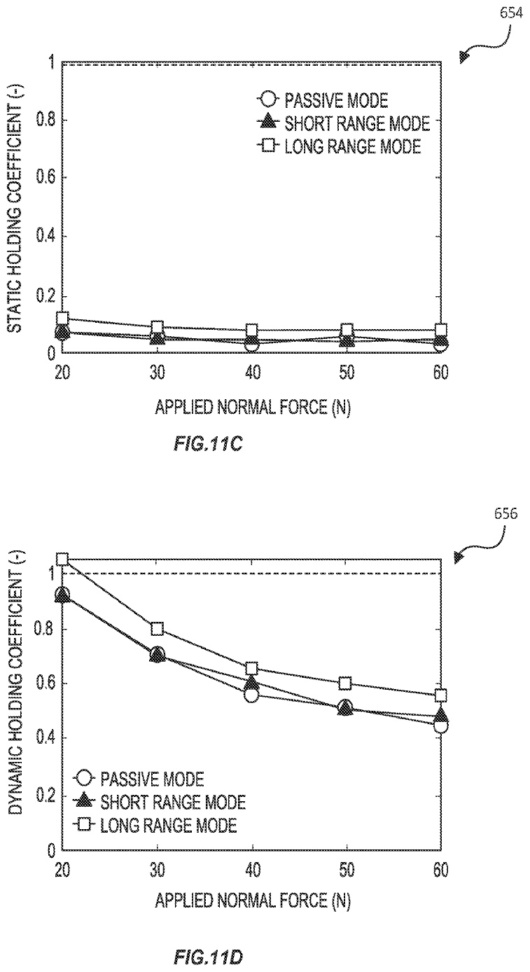

FIGS. 11A-11F are graphs illustrating various tests of a gripping module with an EPM array of EPMs (e.g., such as that disclosed in FIGS. 6 and 7) being operated in three modes of operation: passive; short range; and long-range. In the passive mode of operation, the EPMs are in an off state. In the short range mode of operation, all of the EPMs are turned on. And, in the long-range mode of operation, a portion of the EPMs (e.g., half of the EPMs in the EPM array) have been turned on while the remaining portion remain in the passive state (i.e., off).

These graphs are the results of grasping tests on a PVC pipe with two opposing gripping modules, In these tests, the PVC pipe has a 2.4 inch outer diameter. To the test gripping force of the gripping module, the PVC pipe was subjected to forces in a direction perpendicular to the applied normal force.

First, a definition of forces in the tests are defined. The static holding force is defined as the maximum holding force at a displacement of 0.5 mm. The dynamic holding force is defined as maximum holding force at a displacement of 0.5 R, where R is the radius of the target PVC pipe that was tested. And the static and dynamic holding coefficients are defined by the following equation:

$$Holding Coefficient = \frac{Holding Force}{Applied Normal Force}$$

FIG. 11A is a graph 650 illustrating the static holding force in Newtons (N) versus the applied normal force in N for the three modes of operation of the EPM. FIG. 11B is a graph 652 illustrating the dynamic holding force in N versus the applied normal force for the modes of the EPM. FIG. 11C is a graph 654 illustrating the static holding coefficient versus the applied normal force in N of the EPM. FIG. 11D is a graph 656 illustrating the dynamic holding coefficient versus the applied normal force in N for the three modes of operation of the EPM. FIG. 11E is a graph 658 illustrating the controllable static holding force in N versus the applied normal force in N for the long and short range modes of the EPM. And FIG. 11F is a graph 660 illustrating the controllable dynamic holding force in N versus the applied normal force in N for the long and short range modes of the EPM.

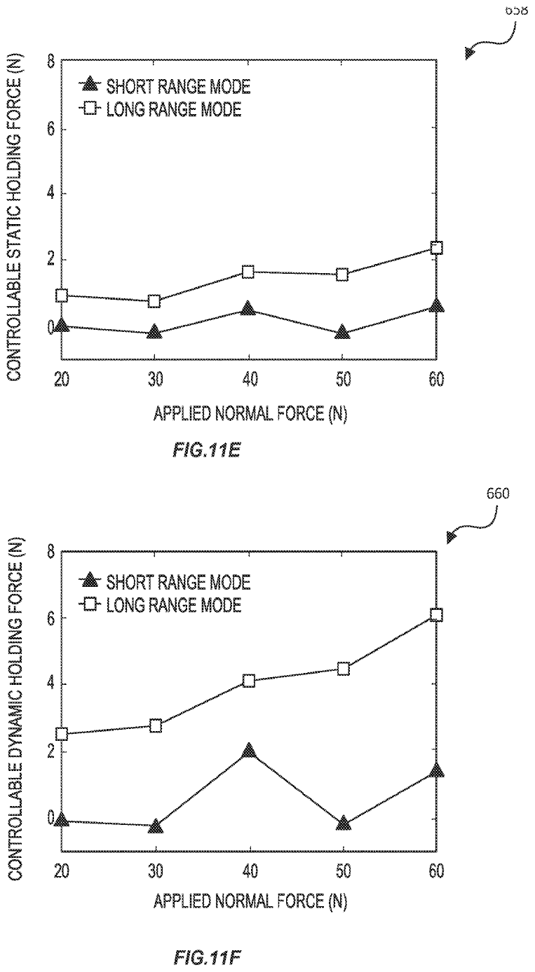

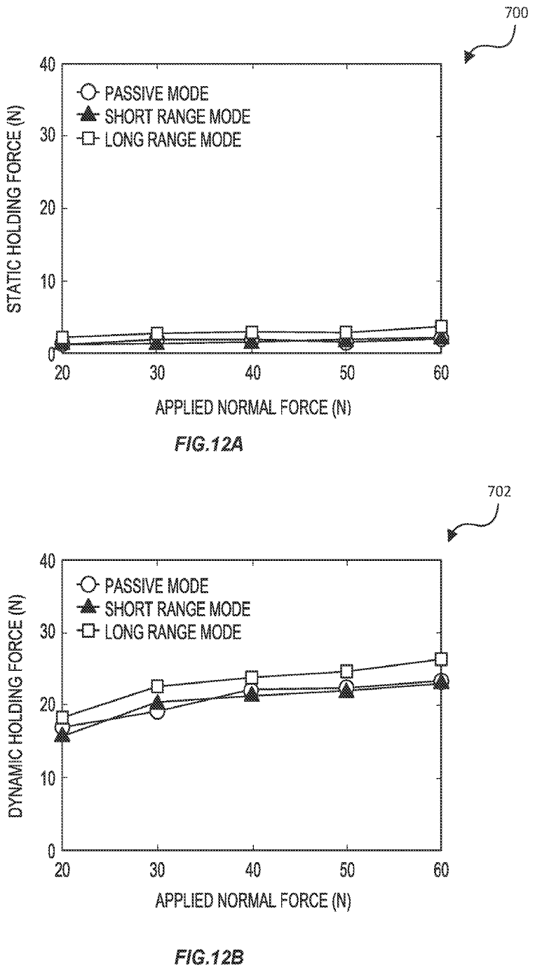

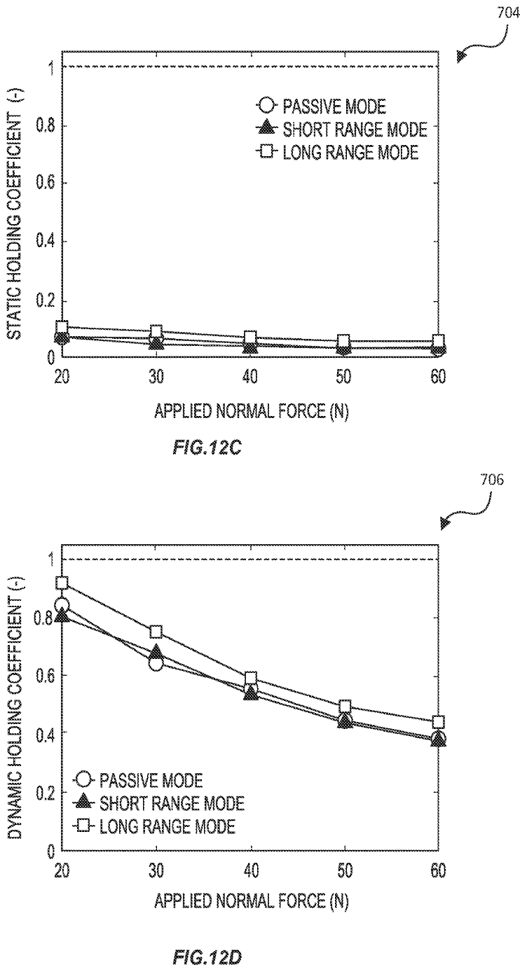

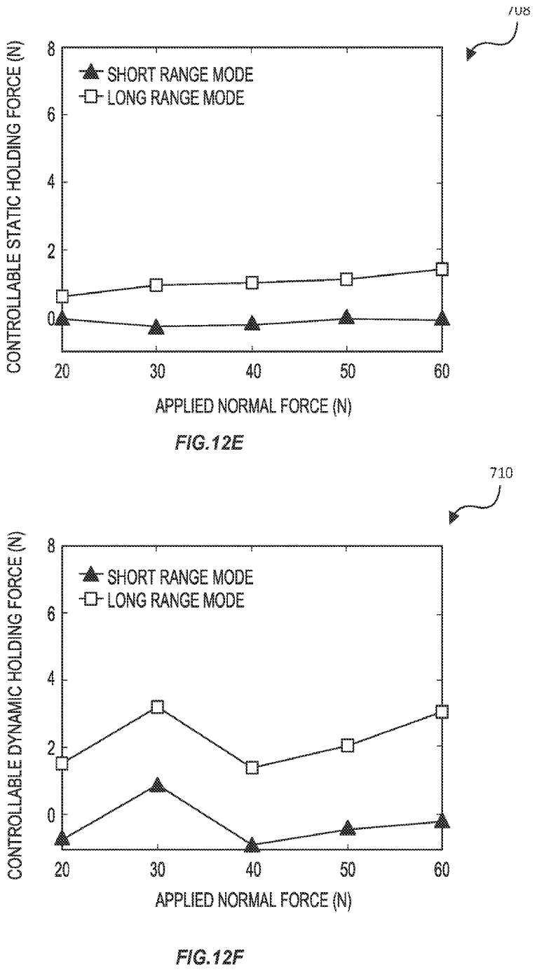

FIGS. 12A-12F are graphs illustrating various tests of the gripping module with an EPM array of EPMs (e.g., such as that disclosed in FIGS. 6 and 7) being operated the passive, short range, and long-range modes of operation. In these tests, the PVC pipe has a 4.3 inch outer diameter. FIG. 12A is a graph 700 illustrating the static holding force in N versus the applied normal force of the three modes of operation of the EPM. FIG. 12B is a graph 702 illustrating the dynamic holding force in N versus the applied normal force in N of the three modes of operation of the EPM. FIG. 12C is a graph 704 illustrating the static holding coefficient versus the applied normal force in N of the three modes of operation of the EPM. FIG. 12D is a graph 706 illustrating the dynamic holding coefficient versus the applied normal force in N for the three modes of operation of the EPM. FIG. 12E is a graph 708 illustrating the controllable static holding force in N versus the applied normal force in N for the short and long-range modes of operation of the EPM. And FIG. 12F is a graph 710 illustrating the controllable dynamic holding force in N versus the applied normal force in N for the short and long-range modes of operation of the PM.

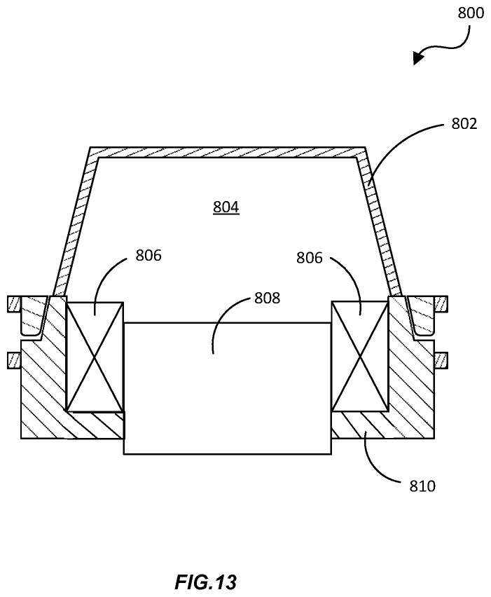

FIG. 13 is a cutaway view of a gripping module 800 employing an electromagnet (EM), as opposed to an EPM. The EM includes an adjustable magnetic core 808 with an electromagnetic coil 806 wrapped about the magnetic core 808. The EM is mounted within a cylindrical aluminum frame 810. The flexible/elastic bladder 802 contains an MR fluid 804. And the flexible/elastic bladder 802 is affixed to the outer cylindrical frame 810. In some embodiments, the outer cylindrical frame may be configured of steel to improve magnetic flux guidance.

The EM requires power to maintain magnetization. For example, electrical current through the electromagnetic coil causes a magnetic field to be directed to the MR fluid 804 residing within the flexible/elastic bladder 802, causing the MR fluid to rigidize. Thus, when the gripping module 800 is positioned in proximity to a target graspable object, the electrical current is directed to flow through the electromagnetic coil 806 while the gripping module 800 is in operation. When the gripping module 800 is to be disengaged from the target graspable object, a control system ceases current to the magnetic core 808 and the magnetic field subsides, causing the bladder 802 with the MR fluid 804 to become flexible/elastic again.

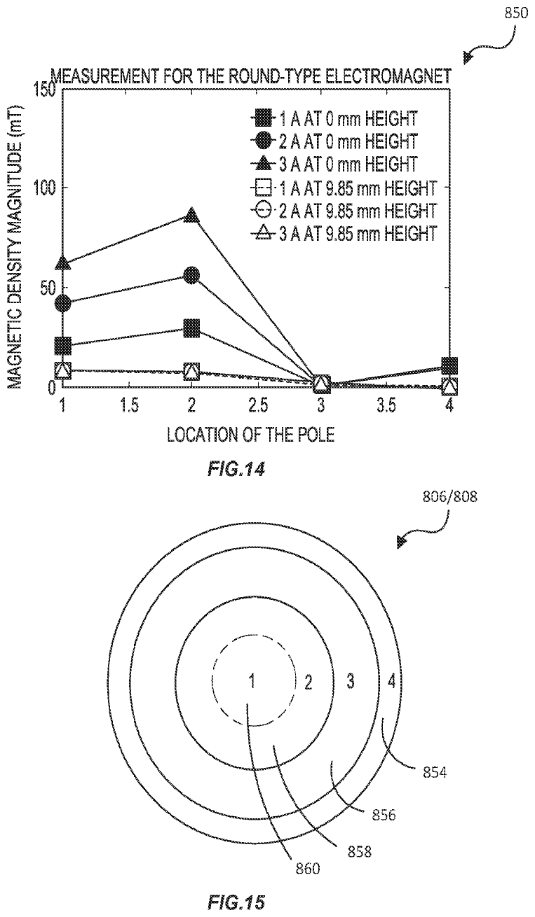

FIG. 14 is a graph 850 illustrating the magnetic density in mT for each pole of the EM in the gripping module 800. And FIG. 15 is an overhead view of the EM (i.e., the electromagnetic coil 806 and the magnetic core 808) illustrating the poll locations 854-860 of the EM.

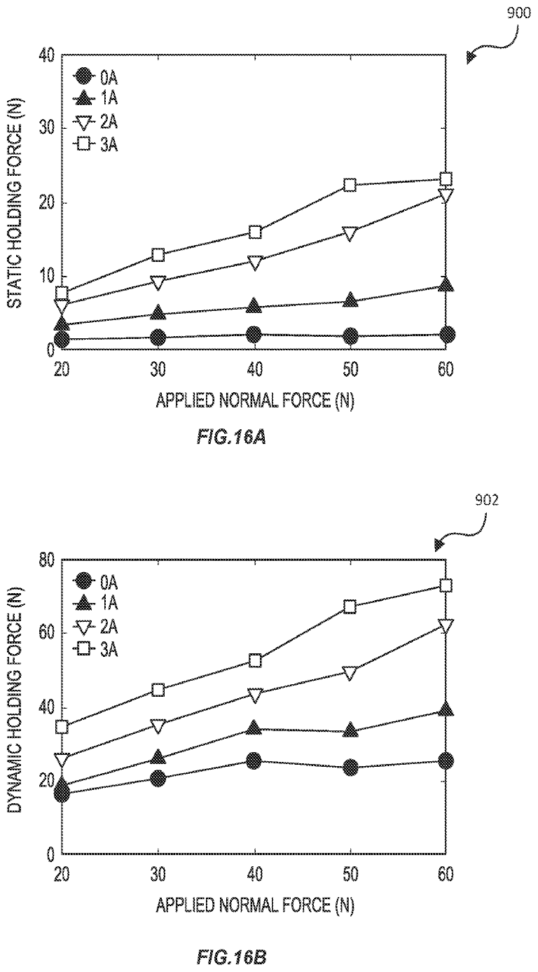

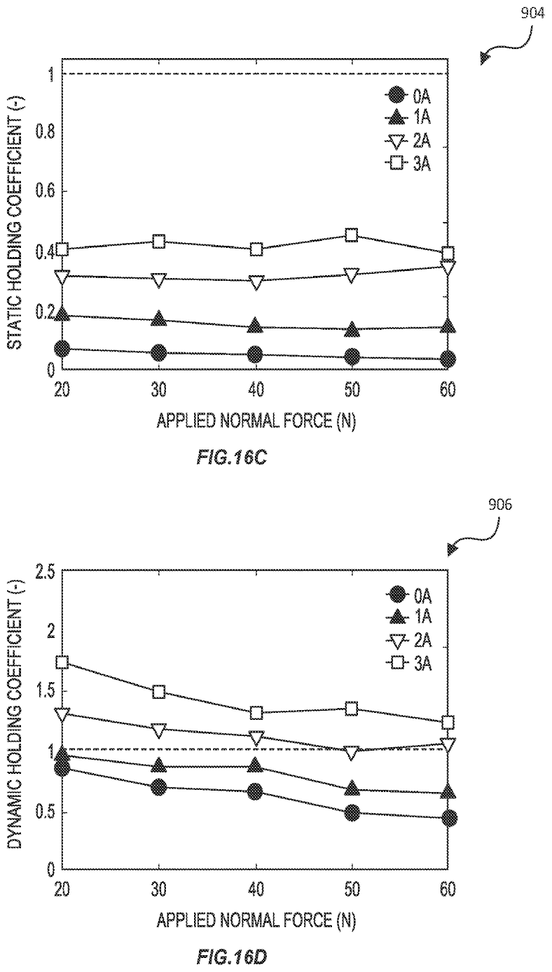

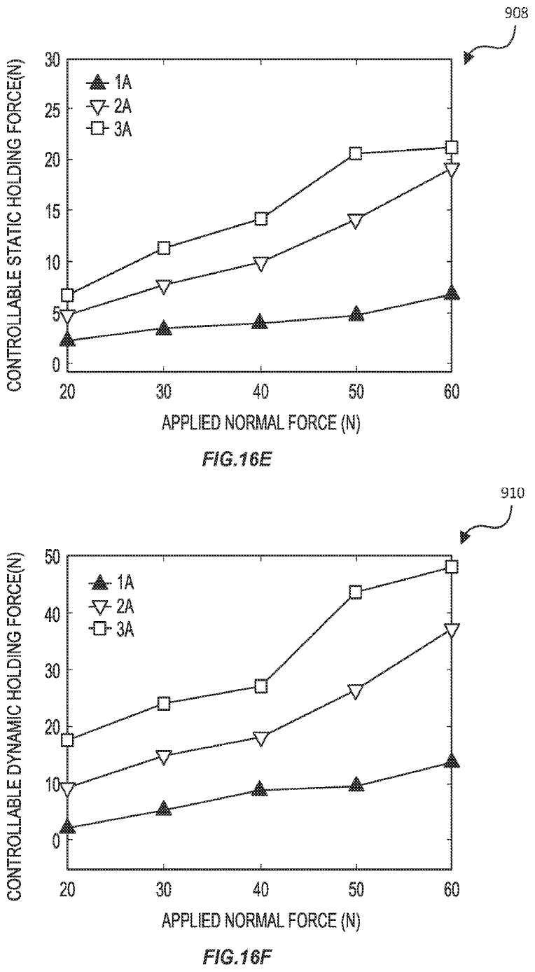

FIGS. 16A-16F are graphs illustrating various tests of a gripping module with an EM (e.g., such as that disclosed in FIG. 13). As mentioned, the EM requires continuous power to maintain a magnetic field. These tests were performed using one ampere (A), 2 A, and 3 A of electrical current through the electromagnetic coil 806, and a normal force of 20 N, 30 N, 40 N, 50 N, and 60 N. The tests were performed on a PVC pipe with a 2.4 inch outer diameter. FIG. 16A is a graph 900 illustrating the static holding force in N versus the applied normal force in N for each tested ampere of electrical current through the EM. FIG. 16B is a graph 902 illustrating the dynamic holding force in N versus the applied normal force N for each tested ampere of electrical current through the EM. FIG. 16C is a graph 904 illustrating the static holding coefficient versus the applied normal force in N for each tested ampere of electrical current through the EM. FIG. 16D is a graph 906 illustrating the dynamic holding coefficient versus the applied normal force in N for each tested ampere of electrical current through the EM. FIG. 16E is a graph 908 illustrating the controllable static holding force in N versus the applied normal force in N for each tested ampere of electrical current through the EM. And FIG. 16F is a graph 910 illustrating the controllable dynamic holding force versus the applied normal force in N for each tested ampere of electrical current through the EM.

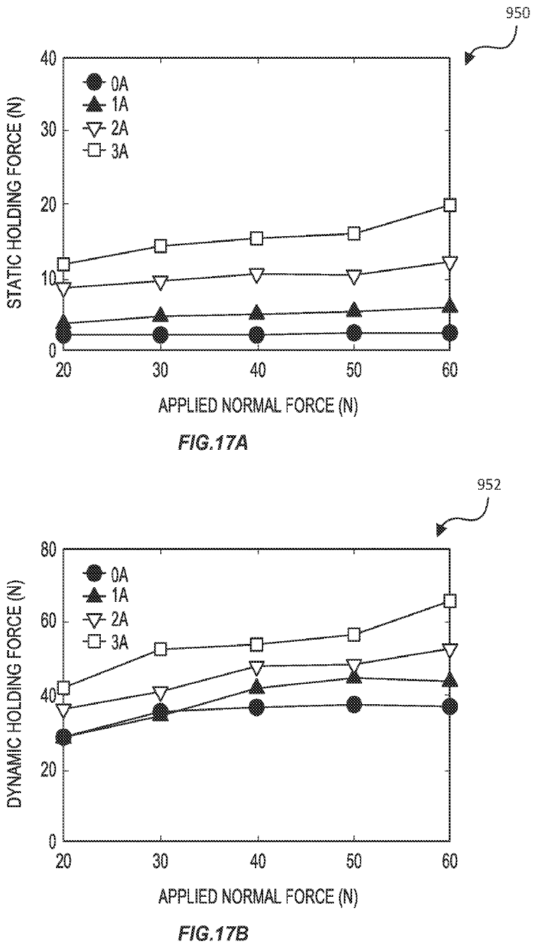

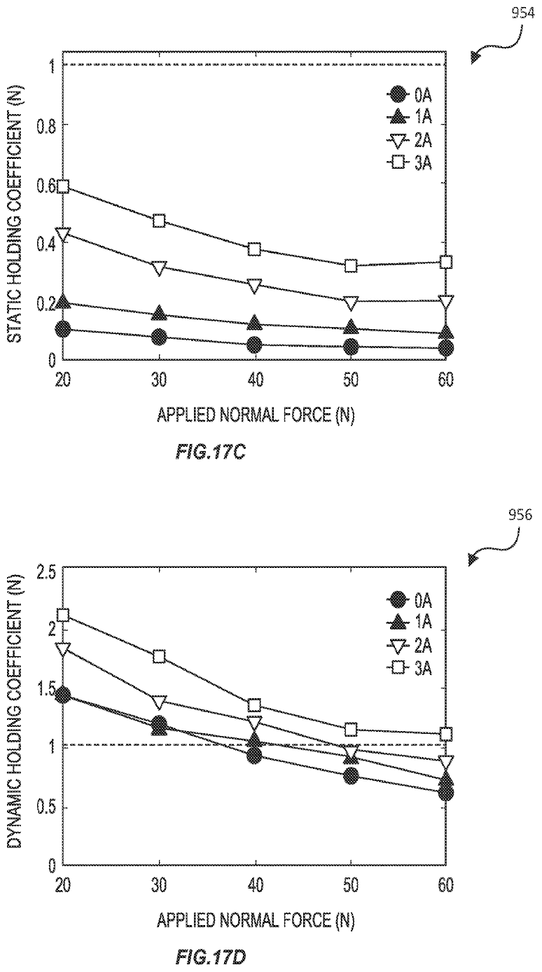

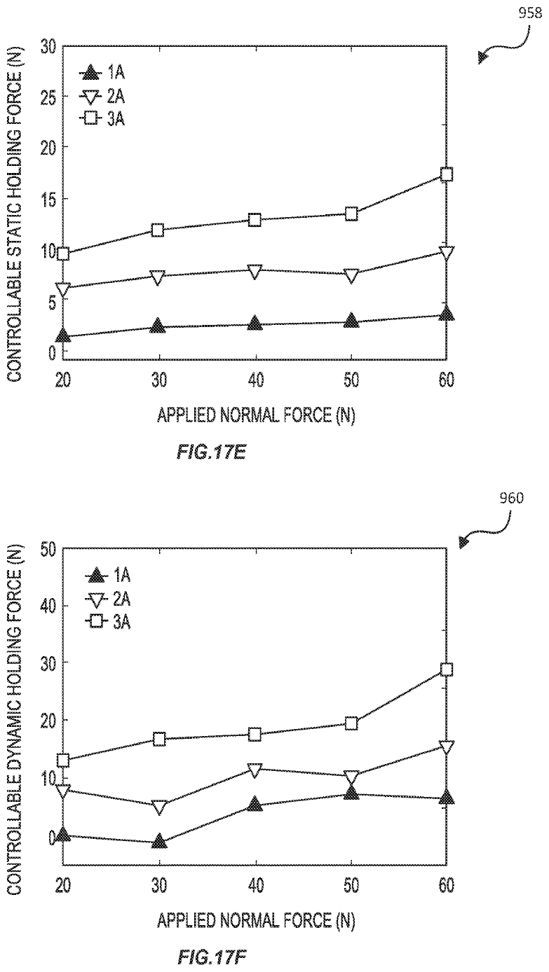

FIGS. 17A-17F are graphs illustrating various tests of a gripping module with an EM (e.g., such as that disclosed in FIG. 13). These tests were again performed using one A, 2 A, and 3 A of electrical current through the electromagnetic coil 806, and a normal force of 20 N, 30 N, 40 N, 50 N, and 60 N. This time however, the tests were performed on a PVC pipe with a 4.3 inch outer diameter. FIG. 17A is a graph 950 illustrating the static holding force in N versus the applied normal force in N for each tested ampere of electrical current through the EM. FIG. 17B is a graph 952 illustrating the dynamic holding force in N versus the applied normal force N for each tested ampere of electrical current through the EM. FIG. 17C is a graph 954 illustrating the static holding coefficient versus the applied normal force in N for each tested ampere of electrical current through the EM. FIG. 17D is a graph 956 illustrating the dynamic holding coefficient versus the applied normal force in N for each tested ampere of electrical current through the EM. FIG. 17E is a graph 958 illustrating the controllable static holding force in N versus the applied normal force in N for each tested ampere of electrical current through the EM. And FIG. 17F is a graph 960 illustrating the controllable dynamic holding force versus the applied normal force in N for each tested ampere of electrical current through the EM.

Any of the various computing and/or control elements shown in the figures or described herein may be implemented as hardware, as a processor implementing software or firmware, or some combination of these. For example, an element may be implemented as dedicated hardware. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

In one embodiment, instructions stored on a computer readable medium direct a computing system of any of the devices and/or servers discussed herein to perform the various operations disclosed herein. In some embodiments, all or portions of these operations may be implemented in a networked computing environment, such as a cloud computing system. Cloud computing often includes on-demand availability of computer system resources, such as data storage (cloud storage) and computing power, without direct active management by a user. Cloud computing relies on the sharing of resources, and generally includes on-demand self-service, broad network access, resource pooling, rapid elasticity, and measured service.

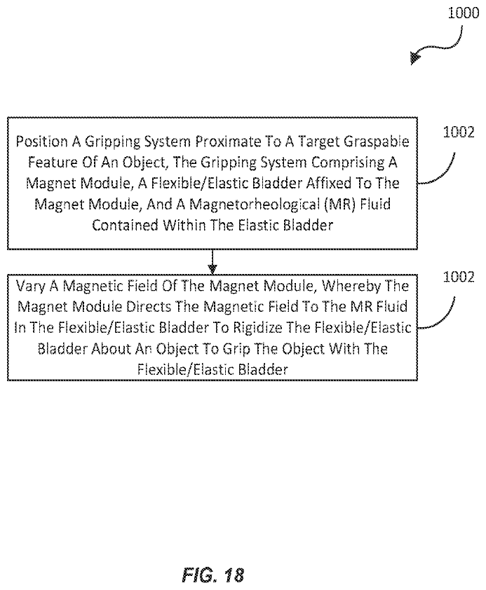

FIG. 18 is a flowchart of an exemplary process 1000 for operating a gripping system in accordance with the embodiments shown and described herein. The process 1000 initiates when a gripping system is position proximate to a target graspable feature of an object, in the process element 1002. The gripping system comprises a magnet module (e.g., magnet module 405 of FIG. 6), a flexible/elastic bladder (e.g., flexible/elastic bladder 402 of FIG. 6) affixed to the magnet module, and a MR fluid (e.g., MR fluid 404 of FIG. 6) contained within the elastic bladder. Once the flexible/elastic engages the target graspable feature of the object, a controller may vary the magnetic field of the magnet module. The magnetic field is directed to the MR fluid in the flexible/elastic bladder, which rigidizes the flexible/elastic bladder about the target graspable feature of the object to grip the object with the flexible/elastic bladder. For example, the magnet module may employ an EPM array. In a long range mode of operation, adjacent EPMs in the array may have opposite poles which may be used to attract the gripping system to the object. Once the flexible elastic bladder engages the target graspable feature of the object, the EPM array may be activated in the short range mode in which each of the poles of the of the EPMs have the same pole (e.g., with the North poles being proximate to the MR fluid in the flexible/elastic bladder). When disengagement from the target graspable feature of the object is desired, a controller may turn the EPMs in the array off such at the flexible/elastic bladder is no longer rigid and releases the target graspable feature of the object.

In an EM embodiment, a controller may direct current through a coil (e.g., electromagnetic coil 806 of FIG. 13) surrounding a magnetic core of the magnet module (e.g., magnetic core 808 of FIG. 13). As long as an electrical current is maintained, the magnetic core directs a magnetic field towards the MR fluid in the flexible/elastic bladder (e.g., MR fluid 804 and flexible/elastic bladder 802 of FIG. 13). And the MR fluid rigidizes the flexible/elastic bladder about the target graspable feature. When disengagement from the target graspable feature of the object is desired, the controller may discontinue the electrical current through the coil such that the flexible/elastic bladder is no longer rigid and releases the target graspable feature of the object.

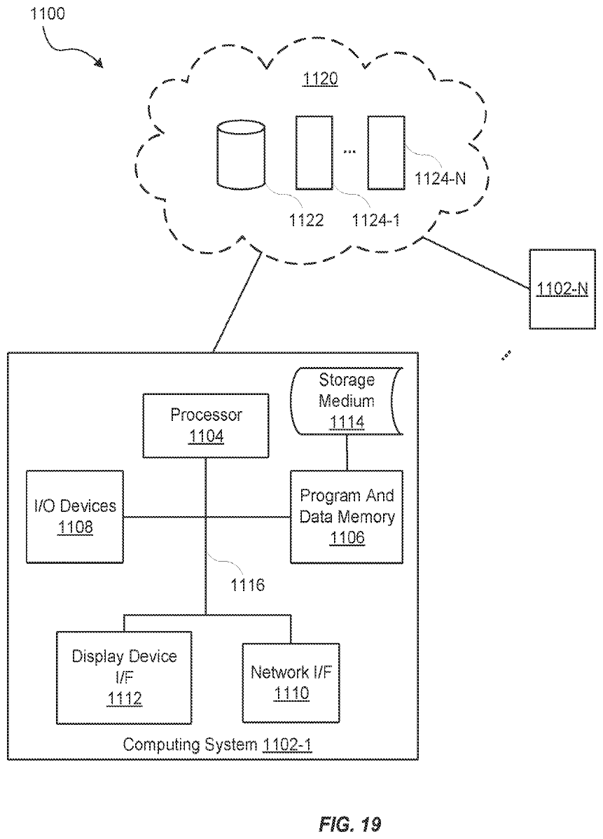

FIG. 19 depicts one illustrative cloud computing system 1100 operable to perform the above operations by executing programmed instructions tangibly embodied on one or more computer readable storage mediums. The cloud computing system 1100 generally includes the use of a network of remote servers hosted on the internet to store, manage, and process data, rather than a local server or a personal computer (e.g., in the computing systems 1102-1, 1102-N). Cloud computing enables users to use infrastructure and applications via the internet, without installing and maintaining them on-premises. In this regard, the cloud computing network 1120 may include virtualized information technology (IT) infrastructure (e.g., servers 1124-1-1124-N, the data storage module 1122, operating system software, networking, and other infrastructure) that is abstracted so that the infrastructure can be pooled and/or divided irrespective of physical hardware boundaries. In some embodiments, the cloud computing network 1120 can provide users with services in the form of building blocks that can be used to create and deploy various types of applications in the cloud on a metered basis.

Various components of the cloud computing system 1100 may be operable to implement the above operations in their entirety or contribute to the operations in part. Some embodiments disclosed herein may utilize instructions (e.g., code/software) accessible via a computer-readable storage medium for use by various components in the cloud computing system 1100 to implement all or parts of the various operations disclosed hereinabove. Examples of such components include the computing systems 1102-1, 1102-N.

Exemplary components of the computing systems 1102-1, 1102-N may include at least one processor 1104, a computer readable storage medium 1114, program and data memory 1106, input/output (I/O) devices 1108, a display device interface 1112, and a network interface 1110. For the purposes of this description, the computer readable storage medium 1114 comprises any physical media that is capable of storing a program for use by the computing system 1102. For example, the computer-readable storage medium 1114 may be an electronic, magnetic, optical, electromagnetic, infrared, semiconductor device, or other non-transitory medium. Examples of the computer-readable storage medium 1114 include a solid-state memory, a magnetic tape, a removable computer diskette, a random access memory (RAM), a read-only memory (ROM), a rigid magnetic disk, and an optical disk. Some examples of optical disks include Compact Disk-Read Only Memory (CD-ROM), Compact Disk-Read/Write (CD-R/W), Digital Versatile Disc (DVD), and Blu-Ray Disc.

The processor 1104 is coupled to the program and data memory 1106 through a system bus 1116. The program and data memory 1106 include local memory employed during actual execution of the program code, bulk storage, and/or cache memories that provide temporary storage of at least some program code and/or data in order to reduce the number of times the code and/or data are retrieved from bulk storage (e.g., a hard disk drive, a solid state drive, or the like) during execution.

Input/output or I/O devices 1108 (including but not limited to keyboards, displays, touchscreens, microphones, pointing devices, etc.) may be coupled either directly or through intervening I/O controllers. Network adapter interfaces 1110 may also be integrated with the system to enable the computing system 1102 to become coupled to other computing systems or storage devices through intervening private or public networks. The network adapter interfaces 1110 may be implemented as modems, cable modems, Small Computer System Interface (SCSI) devices, Fibre Channel devices, Ethernet cards, wireless adapters, etc. Display device interface 1112 may be integrated with the system to interface to one or more display devices, such as screens for presentation of data generated by the processor 1104.

What is claimed is:

1. A gripping system, comprising:
a magnet module;
an elastic bladder affixed to the magnet module;
a magnetorheological (MR) fluid contained within the elastic bladder; and
a controller operable to vary a magnetic field of the magnet module, whereby the magnet module directs the magnetic field to the MR fluid in the elastic bladder to rigidize the elastic bladder about an object to grip the object with the elastic bladder.

2. The gripping system of claim 1, further comprising:
another magnet module; and
another elastic bladder filled with the MR fluid and affixed to the other magnet module,
wherein the controller is further operable to vary a magnetic field of the other magnet module,
whereby the other magnet module directs the magnetic field of the other magnet module to the MR fluid in the other elastic bladder to rigidize the other elastic bladder about the object to grip the object with both elastic bladders.

3. The gripping system of claim 2, further comprising:
a linear actuator configured with the elastic bladders and the magnet modules,
wherein the elastic bladders oppose each other on the linear actuator, and
wherein the controller is operable to move the elastic bladders towards each other via the linear actuator to grip the object.

4. The gripping system of claim 3, wherein:
the clastic bladder and the magnet module are configured on a first arm;
the other elastic bladder and the other magnet module are configured on a second arm hingeably affixed with the first arm to the linear actuator; and
the linear actuator is operable to draw the two arms towards the object from opposing sides of the object.

5. The gripping system of claim 1, wherein:
the magnet module comprises an array of electropermanent magnets (EPMs).

6. The gripping system of claim 5, wherein:
the array is a 4×4 array of EPMs;
the EPMs are activated with adjacent EPMs having opposite poles of magnetic flux in a long range mode of operation; and
the EPMs are activated with adjacent EPMs having same poles of magnetic flux in a short range mode of operation.

7. The gripping system of claim 1, wherein:
the magnet module comprises an electromagnet.

8. A method, comprising:
positioning a gripping system proximate to a target graspable feature of an object, the gripping system comprising a magnet module, an elastic bladder affixed to the magnet module, and a magnetorheological (MR) fluid contained within the elastic bladder; and
via a controller, varying a magnetic field of the magnet module, whereby the magnet module directs the magnetic field to the MR fluid in the elastic bladder to rigidize the elastic bladder about the target graspable feature of the object to grip the object with the elastic bladder.

9. The method of claim 8, wherein:
the gripping system comprises another magnet module, and another clastic bladder filled with the MR fluid and affixed to the other magnet module; and
the method further comprises varying a magnetic field of the other magnet module, whereby the other magnet module directs the magnetic field of the other magnet module to the MR fluid in the other elastic bladder to rigidize the other elastic bladder about the target graspable feature of the object to grip the object with both elastic bladders.

10. The method of claim 9, wherein:
wherein the elastic bladders oppose each other; and
the method further comprises linearly actuating the elastic bladders and the magnet modules to move the elastic bladders towards each other to grip the object.

11. The method of claim 10, wherein:
the elastic bladder and the magnet module are configured on a first arm;
the other elastic bladder and the other magnet module are configured on a second arm hingeably affixed with the first arm to a linear actuator; and
the method further comprises drawing the two arms towards the object from opposing sides of the object via the linear actuator.

12. The method of claim 8, wherein:
the magnet module comprises an array of electropermanent magnets (EPMs).

13. The method of claim 12, wherein:
the array is a 4×4 array of EPMs; and
the method further comprises:
activating adjacent EPMs in the 4×4 array with opposite poles of magnetic flux in a long range mode of operation; and
activating adjacent EPMs in the 4×4 array with same poles of magnetic flux in a short range mode of operation.

14. The method of claim 8, wherein:
the magnet module comprises an electromagnet.

15. A non-transitory computer readable medium comprising instructions that, when executed by a controller, direct the controller to:
position a gripping system proximate to a target graspable feature of an object, the gripping system comprising a magnet module, an elastic bladder affixed to the magnet module, and a magnetorheological (MR) fluid contained within the elastic bladder; and
vary a magnetic field of the magnet module, whereby the magnet module directs the magnetic field to the MR fluid in the elastic bladder to rigidize the elastic bladder about the target graspable feature of the object to grip the object with the elastic bladder.

16. The computer readable medium of claim 15, wherein:
the gripping system comprises another magnet module, and another elastic bladder filled with the MR fluid and affixed to the other magnet module; and
the instructions further direct the controller to vary a magnetic field of the other magnet module, whereby the other magnet module directs the magnetic field of the other magnet module to the MR fluid in the other elastic bladder to rigidize the other elastic bladder about the target graspable feature of the object to grip the object with both elastic bladders.

17. The computer readable medium of claim 16, wherein:
wherein the elastic bladders oppose each other; and
the instructions further direct the controller to linearly actuate the elastic bladders and the magnet modules to move the elastic bladders towards each other to grip the object.

18. The computer readable medium of claim 17, wherein:
the clastic bladder and the magnet module are configured on a first arm;
the other elastic bladder and the other magnet module are configured on a second arm hingeably affixed with the first arm to a linear actuator; and
the instructions further direct the controller to draw the two arms towards the object from opposing sides of the object via the linear actuator.

19. The computer readable medium of claim 15, wherein:
the magnet module comprises at least one of an array of electropermanent magnets (EPMs) or an electromagnet.

20. The computer readable medium of claim 19, wherein:
the array is a 4×4 array of EPMs; and
the instructions further direct the controller to:
activate adjacent EPMs in the 4×4 array with opposite poles of magnetic flux in a long range mode of operation; and
activate adjacent EPMs in the 4×4 array with same poles of magnetic flux in a short range mode of operation.
